(19) United States
(12) Patent Application Publication
(10) Pub. No.: US 2021/0402933 A1
(43) Pub. Date: Dec. 30, 2021

(54) MOTOR VEHICLE INNER TRIM PANEL

(71) Applicant: TREVES PRODUCTS, SERVICES & INNOVATION, Paris (FR)

(72) Inventors: Benoit PHILIPPE, Santa Cristina D'aro - Girona (ES); Joedi GUTIERREZ GARCIA, Paris (FR)

(21) Appl. No.: 17/283,284

(22) PCT Filed: Oct. 8, 2019
(86) PCT No.: PCT/EP2019/077262

§ 371 Date: Sep. 16, 2021

(30) Foreign Application Priority Data
Oct. 9, 2018 (FR) 1859349

(51) Int. Cl. B60R 13/01

(52) U.S. Cl. CPC B60R 13/011

(57) ABSTRACT

The invention concerns a panel with a body in the form of a plate with a front face for receiving a load, and at least one elongate metal profile for flexurally stiffening the body. The elongate metal profile substantially extends from one edge to another opposing edge of the body. the elongate metal profile being formed by a flat steel sheet strip bent along its length along at least one bend line to maximise its moment of inertia along its length, the steel of the sheet having a yield strength higher than 400 MPa, and the strip being bent in the same direction at a right angle along two bend lines.

### CROSS-REFERENCE TO RELATED APPLICATIONS

This application claims the benefit of International application number PCT/EP2019/077262, filed Oct. 8, 2019 and French application number 1859349, filed Oct. 9, 2018 the entire contents of which are incorporated herein by reference.

### TECHNICAL FIELD

The invention relates to a motor vehicle inner trim panel and an architecture for mounting such a panel.

### BACKGROUND

It is known, in particular from document US2013257100-A1, to produce a motor vehicle inner trim panel, said panel comprising:
a body in the general form of a plate having a front face for receiving a load and a back face,
and at least one elongate metal profile for flexurally stiffening said body, said profile extending substantially from one edge to another opposing edge of said body, said edges being intended to bear against two receiving bases integral with the shell body of the vehicle, said profile being formed by a flat steel sheet strip bent along its length along at least one bend line to maximise its moment of inertia along its length, the steel of said sheet having a yield strength higher than 400 MPa.

Such a profile makes it possible to ensure a very good stiffening, but at the expense of a significant weight.

Moreover, various types of profiles are known from the prior art:
made of steel bent by rolling, by means of a roller assembly; however, with such a manufacturing method, it is impossible to use high yield strength steels, particularly higher than 250-300 MPa; as a result there is a need to have a profile of significant section, therefore having a high weight, so that said profile fulfils its stiffening function correctly,
made of extruded aluminium; the advantage is the lightness of such a profile; however, its Young's modulus is low, which results in a significant deformation under load; its yield strength is also low, which prohibits the deposition of significant loads at the risk of permanent deformation of the profile,
made of pultrusion material; the advantage is again the lightness of the profile; however, its Young's modulus is low, which results in significant deformation under load.

### SUMMARY OF THE INVENTION

Faced with all these drawbacks, the aim of the invention is to propose a panel provided with a low-weight profile, not permanently deformable and of high stiffness.

To this end, and according to a first aspect, the invention proposes a motor vehicle inner trim panel, said panel comprising:
a body in the general form of a plate having a front face for receiving a load and a back face,
and at least one elongate metal profile for flexurally stiffening said body, said profile extending substantially from one edge to another opposing edge of said body, said profile being formed by a flat steel sheet strip bent along its length along at least one bend line so as to maximise its moment of inertia along its length, the steel of said sheet having a yield strength higher than 400 MPa,

said strip being bent in the same direction at a right angle along two bend lines, such that said profile has:
two parallel sections extending opposite one another respectively according to each of the faces of the body,
and a junction section of said parallel sections, said junction section extending according to the thickness of said body.

With such an arrangement, we have a very light profile, able to receive a significant load, and this without permanent deformation.

According to a second aspect, the invention proposes an architecture for mounting such a panel.

### BRIEF DESCRIPTION OF THE DRAWINGS

Further specific features and advantages of the invention will appear in the following description, made with reference to the appended figures, wherein:

FIGS. 1a and 1b are partial perspective views of a profile according to a first (FIG. 1a) and a second (FIG. 1b) embodiment,

FIG. 2 is a semi-transparent perspective schematic view of a panel according to one embodiment provided with the profile shown in FIG. 1a, said panel being mounted in a vehicle.

### DETAILED DESCRIPTION

With reference to the figures, a motor vehicle inner trim panel 1 is described—for example a cabin or luggage compartment raised floor, or otherwise a covering shelf for said compartment—said panel comprising:
a body 2 in the general form of a plate having a front face 3 for receiving a load and a back face 4,
and at least one elongate metal profile 5 for flexurally stiffening said body, said profile extending substantially from one edge 6a to another opposing edge 6b of said body, said profile being formed by a flat steel sheet strip bent along its length along at least one bend line 7a,7b so as to maximise its moment of inertia along its length, the steel of said sheet having a yield strength higher than 400 MPa,

said strip being bent in the same direction at a right angle along two bend lines 7a,7b, such that said profile has:
two parallel sections 8a,8b extending opposite one another respectively according to each of the faces 3,4 of the body 2,
and a junction section 9 of said parallel sections, said junction section extending according to the thickness of said body.

The bending of a sheet strip having such a yield strength requires in particular a stamping method, that is forming by pressing between a punch and a die, carried out in one or more steps.

According to one embodiment, the sheet strip has a thickness between 0.3 and 2 mm, the choice of a minimum thickness contributing to reducing the weight of the panel 1.

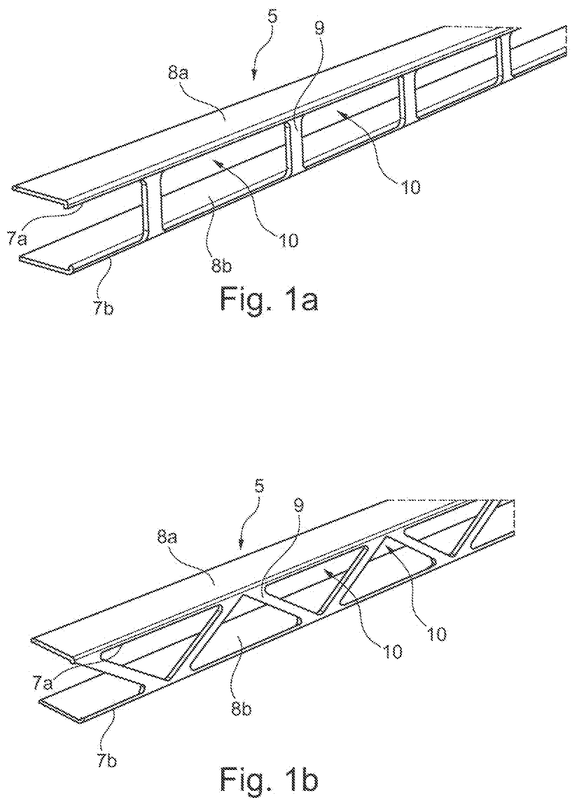

According to the embodiments shown in FIGS. 1a and 1b, the junction section 9—which is the one contributing the least to the moment of inertia of the profile 5 along its length—is provided with weight-reducing perforations 10.

In practice, it is desirable to perforate the junction section 9 as much as possible, this by way of a punching stamping step producing the perforations 10.

According to one embodiment, in order to facilitate the production of the profile 5, the punching may be performed before the bending of the sheet.

According to one embodiment, the surface occupied by the perforations 10 is greater than 85% of the total surface of the junction section 9.

According to the embodiment of FIG. 1a, the perforations 10 define adjacent triangles separated two by two by a junction section strip 9 defining a rib perpendicular to the parallel sections 8a,8b.

According to the embodiment of FIG. 1b, optimising the bending strength of the profile 5, the perforations 10 define adjacent triangles separated two by two by a junction section strip 9 defining an oblique rib—inclined for example at about 45°—relative to the parallel sections 8a,8b.

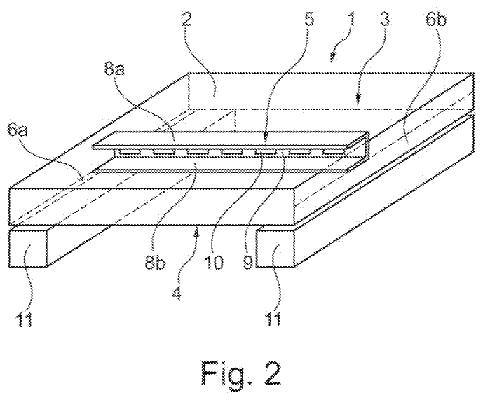

According to the embodiment shown in FIG. 2, the body 2 is made from foam—in particular polyurethane—stiff—that is to say not elastically compressible-, the profile 5 being integrated into the volume of said body that overmoulds it.

It will be noted that, in this case, the perforations 10 described above make it possible to facilitate the distribution of the foam in the mould.

According to one embodiment not shown, the body 2 is made from thermo-compressed felt, the profile 10 being attached to said body.

According to another embodiment not shown, the body 2 is made from a structure forming a regular network of cells—for example honeycomb—, the profile 5 being attached to structure.

In particular, it may be envisaged that the front and back faces of a honeycomb structure are covered with two respective layers of reinforcing fibres, in particular made of glass, each of said layers being impregnated with foam, in particular polyurethane.

In this case, it may be envisaged that the profile 5 is inserted between the structure and one of the layers of fibres.

Finally, it is described, with reference to FIG. 2, an architecture for mounting in a motor vehicle a panel 1 such as described above, said architecture comprising:
two receiving bases 11 integral with the shell body of said vehicle, of two opposing edges 6a, 6b of the body 2 of said panel,
said panel wherein the stiffening profile 5 extends substantially from one of said edges to the other.

What is claimed is:

1. A motor vehicle inner trim panel, the panel comprising:
a body in the general form of a plate having a front face for receiving a load and a back face,
and at least one elongate metal profile for flexurally stiffening the body, the profile extending substantially from a first edge to another opposing second edge of the body, the profile being formed by a flat steel sheet strip bent along its length along at least one bend line to maximise its moment of inertia along its length, the steel of the sheet having a yield strength higher than 400 MPa,
the panel wherein the sheet strip is bent in the same direction at a right angle along two bend lines, the the elongated metal profile having:
two parallel sections extending opposite one another according to each of the front and back faces of the body,
and a junction section of the parallel sections, the junction section extending according to the thickness of the body.

2. A panel according to claim 1, wherein the sheet strip has a thickness between 0.3 and 2 mm.

3. The panel according to claim 1, wherein the junction section is provided with weight-reducing perforations.

4. The panel according to claim 3, wherein the surface occupied by the perforations is greater than 85% of the total surface of the junction section.

5. The panel according to claim 3, wherein the perforations define adjacent triangles separated two by two by a junction section strip defining an oblique rib relative to the parallel sections.

6. The panel according to claim 1, wherein the body is made from a rigid foam, the profile being integrated into the volume of the body that overmoulds it.

7. The panel according to claim 1, wherein the body is made from thermo compressed felt, the profile being attached to the body.

8. The panel according to claim 1, wherein the body is made from a structure forming a regular network of cells, the elongate metal profile being attached to the structure.

9. Architecture for mounting in a motor vehicle a panel according to claim 1, the architecture comprising:
two receiving bases, integral with the shell body of the vehicle, of two opposing edges of the body of the panel,
the panel wherein the elongate metal profile extends substantially from one of the first or second edge to the other edge.
